(19) United States
(12) Patent Application Publication
(10) Pub. No.: US 2006/0237274 A1
(43) Pub. Date: Oct. 26, 2006

(54) Shock absorbing device for cycle

(76) Inventor: Chun Mei Hsia, Taichung (TW)

Correspondence Address: CHARLES E. BAXLEY, ESQ., 90 JOHN STREET, THIRD FLOOR, NEW YORK, NY, 10038, US

(21) Appl. No.: 11/094,652

(22) Filed: Mar. 30, 2005

(51) Int. Cl. F16F 9/00

(52) U.S. Cl. 188/316

(57) ABSTRACT

A shock absorbing device for cycles includes a housing having a chamber to receive a fluid, a spindle rotatably attached to the housing and having a gear, a piston slidably received in the housing and having a notch to form two end segments and having a rack for engaging with the gear of the spindle, to allow the spindle to move the piston relative to the housing when the spindle is rotated relative to the housing. A spring member is engaged with the piston, and an end cover is threaded to the housing, and engaged with the spring member to adjust a spring biasing force of the spring member against the piston when the end cover is threaded and adjusted relative to the housing.

### BACKGROUND OF THE INVENTION

1. Field of the Invention

The present invention relates to a shock absorbing device, and more particularly to a shock absorbing device having a concealed spring member adjustable to different spring biasing forces, for providing a suitable spring or cushioning structure to cycles, such as bicycles, motorcycles, etc.

2. Description of the Prior Art

Typical shock absorbing devices have been widely developed for providing a suitable spring or cushioning force to cycles, such as bicycles, motorcycles, etc., and comprise one or more spring members disposed on the seat posts, or the like, for directly absorbing shocks or vibrations that may be transmitted to the seat cushions of the cycles.

For example, U.S. Pat. No. 4,997,232 to Johnsen, and U.S. Pat. No. 5,024,413 to Papp disclose two of the typical shock absorbing devices each comprising one or more spring members disposed on the seat posts, or disposed between the seat cushions and the cycle frames, for absorbing shocks or vibrations that may be transmitted to the seat cushions of the cycles while riding the cycles. However, the spring members are exposed, and may hurt people inadvertently.

U.S. Pat. No. 5,316,259 to Pawlykowych et al. disclose another typical shock absorbing device comprising one or more spring members disposed between the seat cushions and the cycle frames, and engaged with the seat posts, for absorbing shocks or vibrations that may be transmitted to the seat cushions of the cycles. However, the spring members are deeply received in an outer tube or housing, and may not be adjusted to different spring biasing forces by the users.

U.S. Pat. No. 4,880,213 to Shinbori et al. discloses a further typical shock absorbing device comprising a cylinder housing having a piston portion disposed within the cylinder housing, to form an oil chamber and a gas chamber inside the cylinder housing, and a damping force generating mechanism includes a flexible bladder disposed in the cylinder housing, for dividing the oil and gas chambers completely.

However, an additional hydraulic chamber is required to be formed or provided for receiving the hydraulic fluid when the hydraulic fluid received in the oil chamber or in the additional hydraulic chamber is compressed by the piston portion, such that a complicated configuration may be required and formed for the typical shock absorbing device.

The present invention has arisen to mitigate and/or obviate the afore-described disadvantages of the conventional shock absorbing devices.

### SUMMARY OF THE INVENTION

The primary objective of the present invention is to provide a shock absorbing device including a concealed spring member adjustable to different spring biasing forces, for providing a suitable spring or cushioning structure to cycles, such as bicycles, motorcycles, etc.

The other objective of the present invention is to provide a shock absorbing device including an oil or hydraulic fluid received therein for further providing suitable spring cushioning forces to the cycles.

In accordance with one aspect of the invention, there is provided a shock absorbing device comprising a housing including a chamber formed therein to receive a fluid therein, a spindle rotatably attached to the housing, and extending through the chamber of the housing, and including a gear provided thereon, and including two ends extended out of the housing for coupling to objects, a piston slidably received in the chamber of the housing, and including a notch formed therein for receiving the spindle, and to define two end segments, and including a rack provided in the notch thereof, for engaging with the gear of the spindle, to allow the spindle to move the piston relative to the housing when the spindle is rotated relative to the housing, and a spring member disposed within the chamber of the housing, and engaged with the piston, for biasing against the piston when the piston is moved relative to the housing.

The housing includes an inner thread formed therein, and an end cover threaded with the inner thread of the housing, to openably enclose the chamber of the housing, the end cover is engaged with the spring member to adjust a spring biasing force of the spring member against the piston when the end cover is threaded and adjusted relative to the housing.

One of the end segments of the piston includes an aperture formed therein, for allowing the fluid to flow through the end segment of the piston, and to allow the piston to slide and move relative to the housing.

Alternatively, one of the end segments of the piston includes two through passages formed therein, for allowing the fluid to flow through the first end segment of the piston, and to allow the piston to slide and move relative to the housing. The piston includes two check valves disposed in the through passages thereof, and disposed in different direction to each other.

The check valves of the piston each includes a spring element disposed in the through passages of the piston respectively, and engaged with a projection, to bias the projection to selectively block the through passages of the piston. The check valves of the piston each includes a lock nut threaded to the piston and engaged with the spring element, for adjusting a spring biasing force of the spring, element against the projection. The lock nut includes a hole formed therein, for allowing the fluid to flow through the lock nut and the piston.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a cycle having a shock absorbing device in accordance with the present invention;

FIG. 2 is a partial exploded view of the shock absorbing device for the cycle;

FIG. 3 is a partial cross sectional view of the shock absorbing device, taken along lines 3-3 of FIG. 4;

FIG. 4 is a partial cross sectional view of the shock absorbing device, taken along lines 4-4 of FIG. 3;

FIG. 5 is a plan schematic view similar to FIG. 1, illustrating another arrangement of the shock absorbing device;

FIG. 6 is a plan schematic view similar to FIGS. 1 and 5, illustrating a further arrangement of the shock absorbing device;

FIG. 7 is a plan schematic view similar to FIGS. 1, 5 and 6, illustrating the other arrangement of the shock absorbing device;

FIG. 8 is a plan schematic view similar to FIGS. 1, 5-6 and 7, illustrating a still further arrangement of the shock absorbing device;

FIG. 9 is a partial cross sectional view of the shock absorbing device, taken along lines 9-9 of FIG. 10;

FIG. 10 is a partial cross sectional view of the shock absorbing device, taken along lines 10-10 of FIG. 9; and

FIG. 11 is a partial cross sectional view similar to FIG. 9, illustrating the operation of the shock absorbing device.

### DETAILED DESCRIPTION OF THE PREFERRED EMBODIMENT

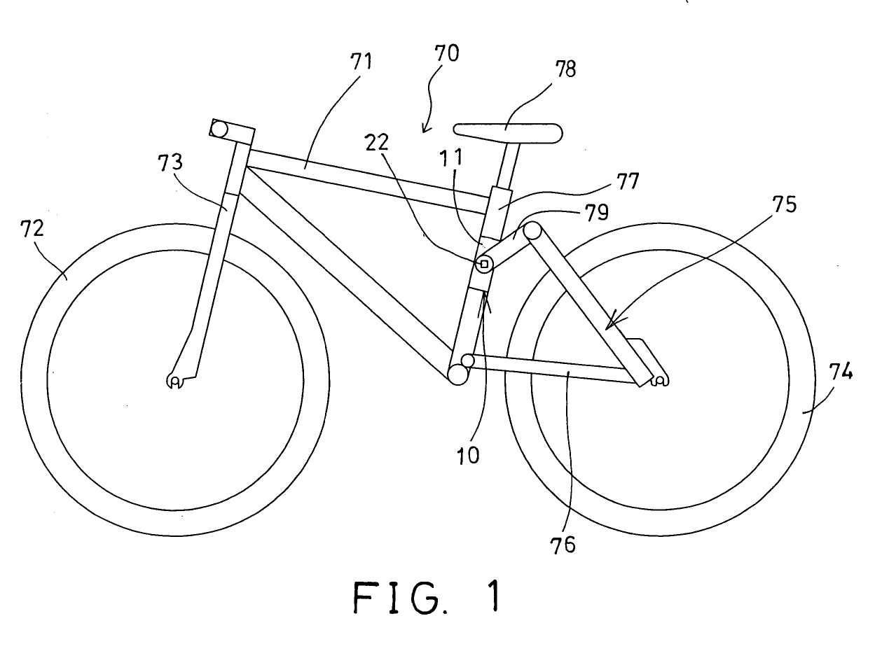

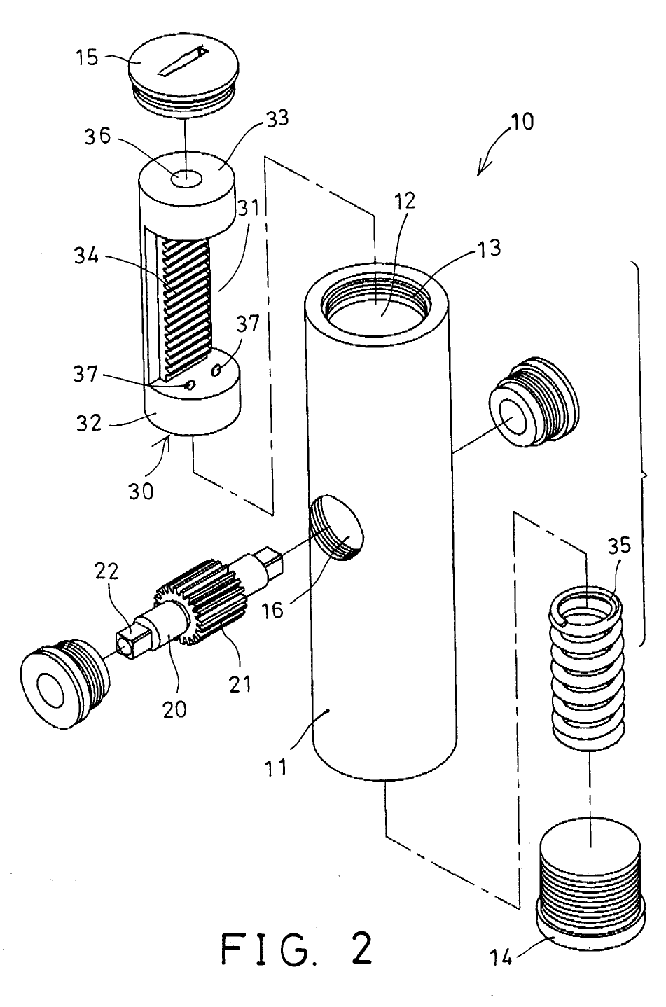

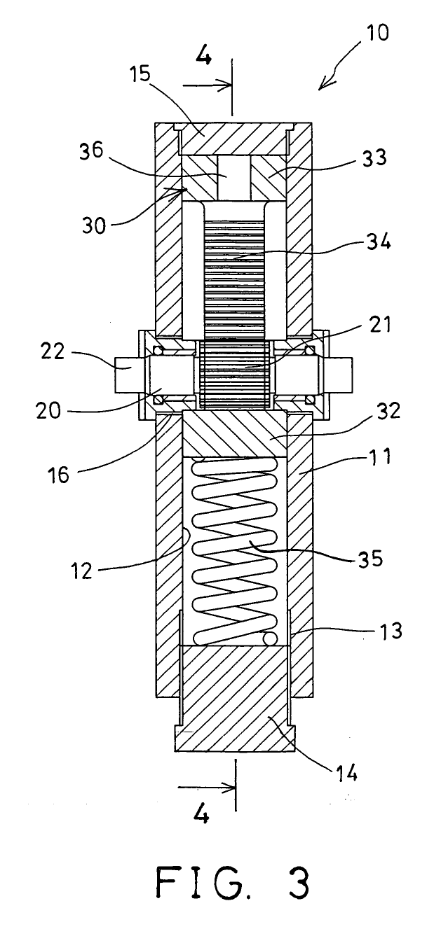

Referring to the drawings, and initially to FIGS. 1-4, a shock absorbing device 10 in accordance with the present invention is provided and arranged for attaching to a cycle 70, such as a bicycle 70, a motorcycle 70, or the like, and for providing a suitable spring or cushioning force to the cycle 70. The cycle 70 normally includes a frame 71, a front wheel 72 attached to a front fork 73, a rear wheel 74 attached to one or more rear forks 75, 76. The frame 71 includes a seat post 77 having a seat or seat cushion 78 disposed or provided thereon, for supporting the riders.

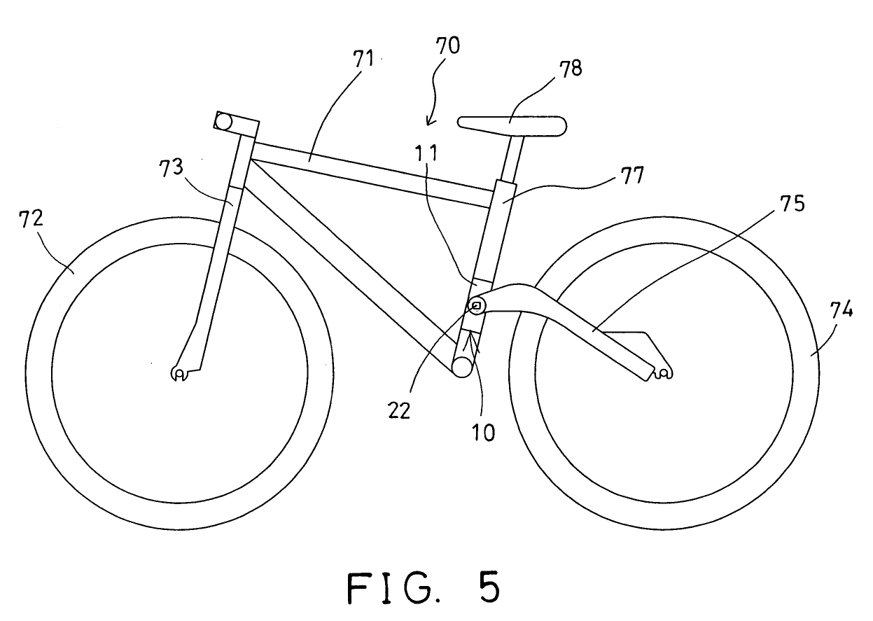

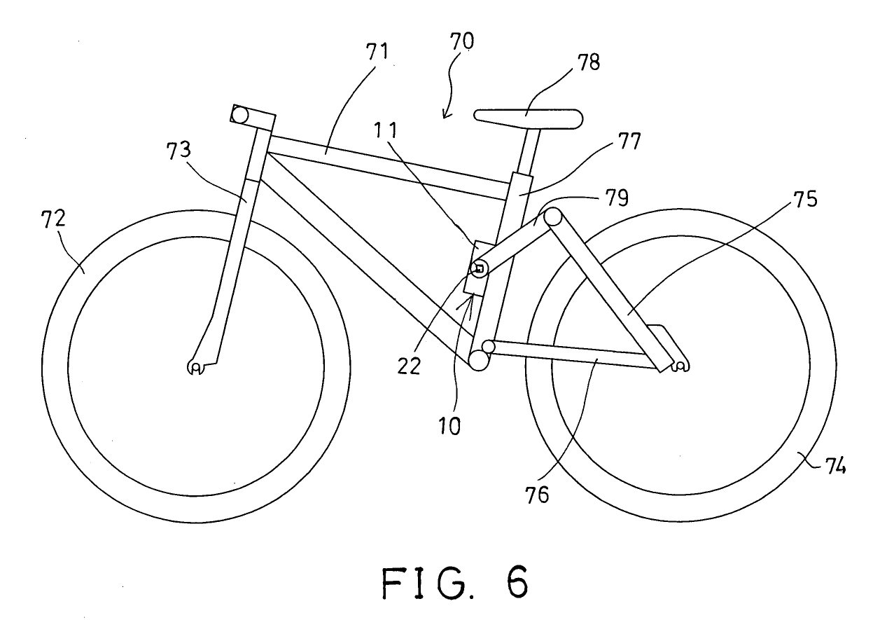

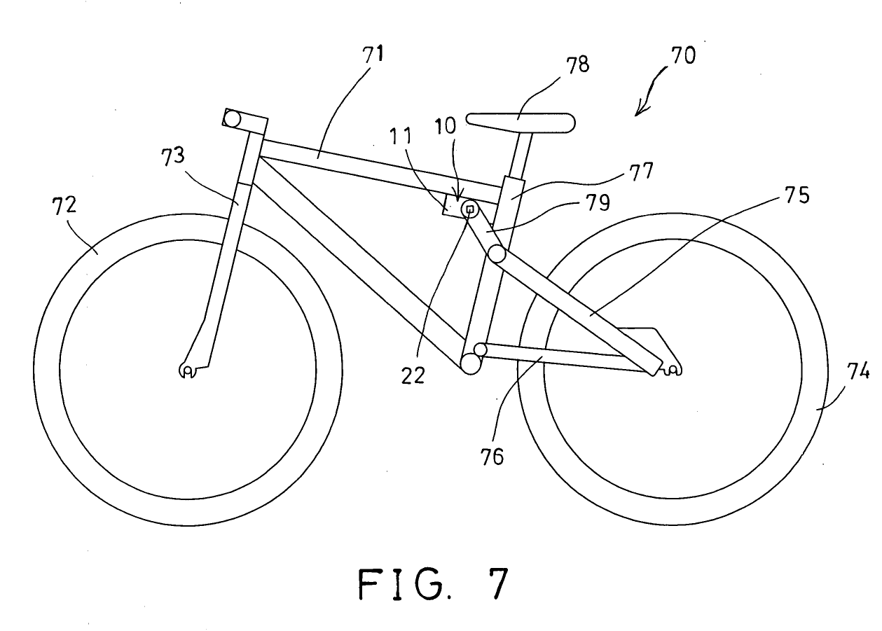

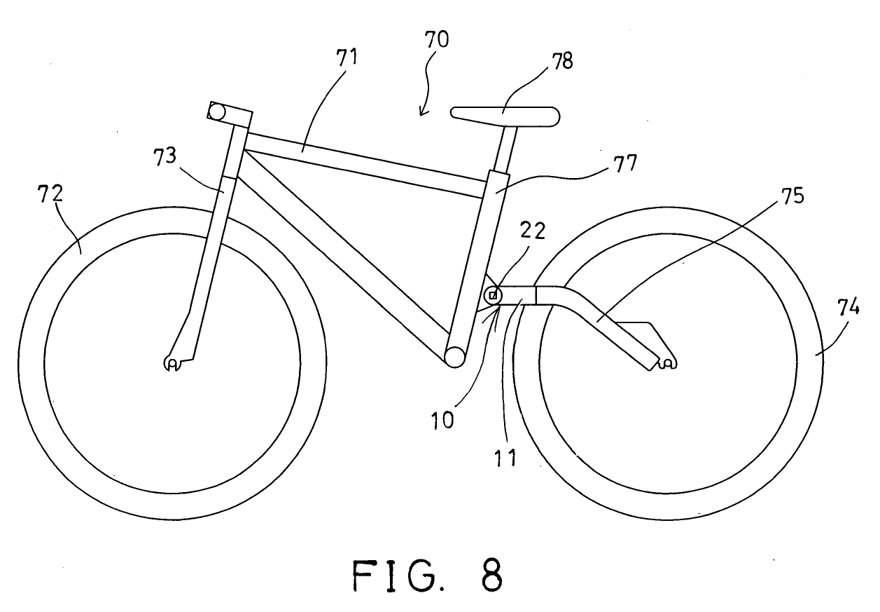

For example, the shock absorbing device 10 includes a housing 11 for attaching to or disposed in an intermediate portion of the seat post 77 (FIG. 1), attaching to a side portion of the seat post 77 (FIG. 5), attaching to a front portion of the seat post 77 (FIG. 6), attaching to an upper portion of the seat post 77 (FIG. 7), or attaching to a rear portion of the seat post 77 (FIG. 8), for providing a suitable spring or cushioning force between the frame 71 or the seat post 77 and the rear forks 75, 76. The shock absorbing device 10 may be attached or secured to the seat post 77 or to the frame 71 with fasteners (not shown), latches (not shown), or by welding processes, for example.

As shown in FIGS. 1-4, the shock absorbing device 10 includes a chamber 12 formed or provided within the housing 11, and the housing 11 includes two ends each having an inner thread 13 formed or provided therein for detachably securing or threading with end covers 14, 15 thereto, and for openably enclosing the chamber 12 of the housing 11. For example, the end cover 14 is threaded to the inner thread 13 of the housing 11, for moving or adjusting relative to the housing 11.

The housing 11 includes an orifice 16 laterally formed or provided therein for rotatably receiving a spindle 20 therein. The spindle 20 may be rotated relative to the housing 11 only, but may not be slid or moved relative to the housing 11. The spindle 20 is extended through the chamber 12 of the housing 11, and includes a gear 21 formed or provided thereon, and includes one or more ends 22 extended out of the housing 11, for coupling to objects, such as the rear forks 75, 76 directly (FIGS. 5, 8), or indirectly via one or more links 79 (FIGS. 1 and 6-7). It is preferable that the ends 22 of the spindle 20 includes a non-circular cross section for allowing the spindle 20 to be effectively rotated by the links 79.

A piston 30 is slidably received in the housing 11, and includes a notch 31 formed and provided in an intermediate portion thereof, for receiving the spindle 20, and to form or define two end segments 32, 33, and includes a rack 34 formed or provided in the notch 31 thereof, for engaging with the gear 21 of the spindle 20, and thus for allowing the spindle 20 to move the piston 30 along the housing 11 when the spindle 20 is rotated relative to the housing 11. Another spring member 35 may further be provided and disposed within the chamber 12 of the housing 11, and engaged with the piston 30, for biasing against the piston 30.

The chamber 12 of the housing 11 may further be provided to receive an oil or a hydraulic fluid therein. One of the end segments 32, 33, such as the upper end segment 33 of the piston 30 includes an aperture 36 formed therein, for allowing the oil or hydraulic fluid to flow through the upper end segment 33 of the piston 30, and thus for allowing the piston 30 to slide or move relative to the housing 11.

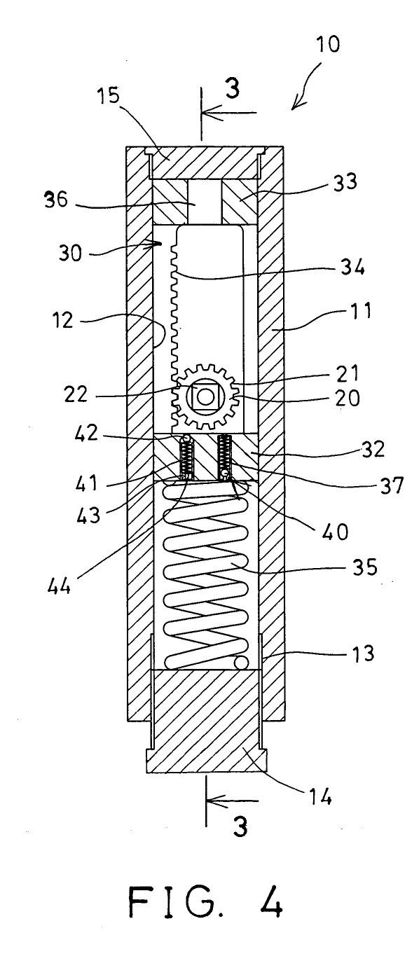

The other end segment 32, such as the lower end segment 32 of the piston 30 includes two through passages 37 formed therein (FIG. 4), for receiving check valves 40 therein. Each of the check valves 40 includes a spring element 41 disposed in the respective through passages 37 of the lower end segment 32 of the piston 30, and engaged with a ball or projection 42, for biasing the projection to selectively block the through passages 37 of the lower end segment 32 of the piston 30, and a lock nut 43 threaded to the lower end segment 32 of the piston 30, and engaged with the spring element 41, for adjusting the spring biasing force of the spring element 41 against the ball or projection 42.

The lock nut 43 includes a hole 44 formed therein, for allowing the oil or hydraulic fluid to flow through the lock nut 43 and thus the lower end segment 32 of the piston 30. In addition, the two check valves 40 are disposed in different directions, to allow the oil or hydraulic fluid to flow through the lower end segment 32 of the piston 30, and thus to allow the piston 30 to slide or move relative to the housing 11.

It is to be noted that the lock nut 43 may be threaded with the lower end segment 32 of the piston 30, and engaged with the spring element 41, to adjust the spring biasing force of the spring element 41 against the ball or projection 42. In addition, the end cover 14 may also be threaded to the inner thread 13 of the housing 11, and may also be engaged with the spring member 35, to adjust the spring biasing force of the spring member 35 against the piston 30 or against the cycle 70.

In operation, as shown in FIGS. 1 and 5-7, while riding the cycle 70, the rear wheel 74 and thus the rear forks 75, 76 may be caused or forced to rotate relative to the seat post 77 and/or the frame 71, and may thus rotate the spindle 20 relative to the housing 11. The rotational movement of the spindle 20 may then force and actuate the rack 34 and the piston 30 to slide or move along the chamber 12 of the housing 11, against the spring member 35, and also against the oil or hydraulic fluid received within the chamber 12 of the housing 11.

After the forces applied onto the spindle 20 is released, the spring member 35 may bias and recover the piston 30 upwardly to the original position, such that the spring member 35 and the oil or hydraulic fluid may be used to suitably cushion the cycle 10, or to provide a cushioning force between the rear wheel 74 and the rear forks 75, 76 and the seat post 77 and the frame 71.

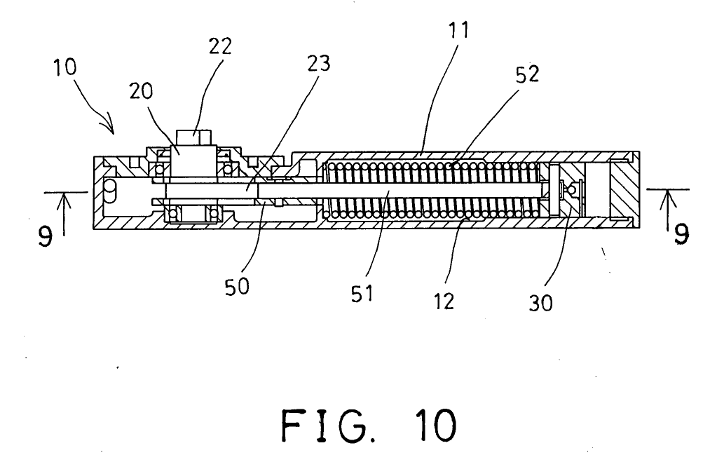

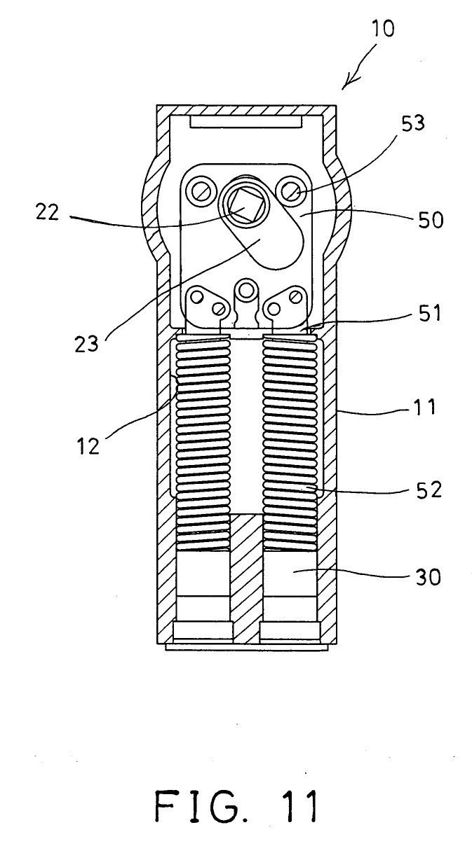

Alternatively, as shown in FIGS. 8-11, the housing 11 may also include a chamber 12 formed therein to receive an oil or hydraulic fluid therein, and to slidably receive one or more pistons 30 therein, and further includes a follower 50 slidably received in the chamber 12 of the housing 11, and pivotally coupled to the pistons 30 with one or more links 51, and one or more spring members 53 engaged onto the links 51, and engaged or biased between the follower 50 and the pistons 30.

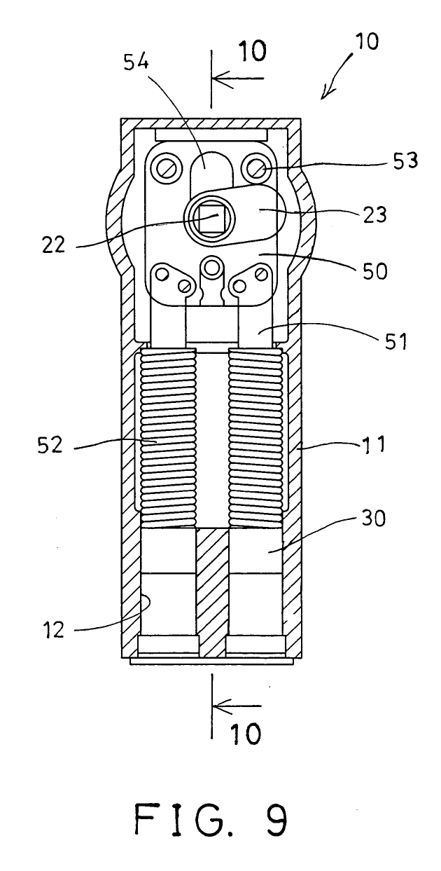

The follower 50 includes an extension or a roller 53 extended therefrom, and includes an oblong hole 54 formed therein (FIG. 9), to slidably receive a spindle 20. The spindle 20 includes a finger or actuator 23 attached thereto, or extended therefrom, for engaging with the projection or roller 53 of the follower 50, and for moving the follower 50 along the chamber 12 of the housing 11, against the spring members 52, and also against the oil or hydraulic fluid received within the chamber 12 of the housing 11. The spindle 20 also includes two non-circular ends 22 for coupling to the frame 71 of the cycle 70, for example.

Accordingly, the shock absorbing device in accordance with the present invention includes concealed spring member adjustable to different spring biasing forces, for providing a suitable spring or cushioning structure to cycles, such as bicycles, motorcycles, etc, and includes a hydraulic fluid received therein for further providing suitable spring cushioning forces to the cycles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A shock absorbing device comprising:
a housing including a chamber formed therein to receive a fluid therein,
a spindle rotatably attached to said housing, and extending through said chamber of said housing, and including a gear provided thereon, and including two ends extended out of said housing for coupling to objects,
a piston slidably received in said chamber of said housing, and including a notch formed therein for receiving said spindle, and to define two end segments, and including a rack provided in said notch thereof, for engaging with said gear of said spindle, to allow said spindle to move said piston relative to said housing when said spindle is rotated relative to said housing, and
a spring member disposed within said chamber of said housing, and engaged with said piston, for biasing against said piston when said piston is moved relative to said housing.

2. The shock absorbing device as claimed in claim 1, wherein said housing includes an inner thread formed therein, and an end cover threaded with said inner thread of said housing, to openably enclose said chamber of said housing, said end cover is engaged with said spring member to adjust a spring biasing force of said spring member against said piston when said end cover is threaded and adjusted relative to said housing.

3. The shock absorbing device as claimed in claim 1, wherein a first end segment of said end segments of said piston includes an aperture formed therein, for allowing said fluid to flow through said first end segment of said piston, and to allow said piston to slide and move relative to said housing.

4. The shock absorbing device as claimed in claim 1, wherein a first end segment of said end segments of said piston includes two through passages formed therein, for allowing said fluid to flow through said first end segment of said piston, and to allow said piston to slide and move relative to said housing.

5. The shock absorbing device as claimed in claim 4, wherein said piston includes two check valves disposed in said through passages thereof, and disposed in different direction to each other.

6. The shock absorbing device as claimed in claim 5, wherein said check valves of said piston each includes a spring element disposed in said through passages of said piston respectively, and engaged with a projection, to bias said projection to selectively block said through passages of said piston.

7. The shock absorbing device as claimed in claim 6, wherein said check valves of said piston each includes a lock nut threaded to said piston and engaged with said spring element, for adjusting a spring biasing force of said spring element against said projection.

8. The shock absorbing device as claimed in claim 7, wherein said lock nut includes a hole formed therein, for allowing said fluid to flow through said lock nut and said piston.
